(19) United States
(12) Patent Application Publication
(10) Pub. No.: US 2006/0246915 A1
(43) Pub. Date: Nov. 2, 2006

(54) Remote control of mobile telephone user interface

(76) Inventor: Vineet Shrivastava, San Marcos, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/117,966

(22) Filed: Apr. 29, 2005

(51) Int. Cl. H04Q 7/20

(52) U.S. Cl. 455/445; 455/566

(57) ABSTRACT

A method of operating a cellular telephone includes generating display data which represents a user interface display suitable for presentation on a display component of the cellular telephone. The method also includes transmitting the display data to a cellular telephone network that is in communication with the cellular telephone.

### TECHNICAL FIELD

The present disclosure relates to cellular telephones.

### BACKGROUND

Users of mobile (also referred to as “cellular”) telephones sometimes are confused by the user interfaces offered by the phones and/or have difficulty navigating among and/or operating some features of the phones. It has been proposed to provide call-in help centers to answer questions from mobile phone users, but it may be the case that an explanation offered to the user via a telephone call is difficult to understand, or a considerable amount of time may be required for the user's problem to be solved.

### SUMMARY

Methods, systems, and computer program code are therefore presented for allowing a mobile telephone's user interface to be viewed and controlled remotely.

According to some embodiments, a method of operating a cellular telephone is provided. The method includes generating display data which represents a user interface display suitable for presentation on a display component of the cellular telephone. The method also includes transmitting the display data to a cellular telephone network that is in communication with the cellular telephone.

According to some embodiments, the method may further include receiving a command that was generated by a computer and transmitted to the cellular telephone via the cellular telephone network. The method may further include responding to the command by generating updated display data which represents an updated user interface display, and transmitting the updated display data to the cellular telephone network.

According to some embodiments, a method of operating a cellular telephone is provided. The method includes receiving and displaying, at a computer, user interface display data generated by the cellular telephone and transmitted to the computer via a cellular telephone network. The method also includes controlling the cellular telephone by commands generated by the computer and transmitted to the cellular telephone via the cellular telephone network.

### BRIEF DESCRIPTION OF THE DRAWINGS

Further aspects of the instant system will be more readily appreciated upon review of the detailed description of the preferred embodiments included below when taken in conjunction with the accompanying drawings, of which:

FIG. 1 is a schematic simplified block diagram of a communication system operated in accordance with aspects of the present invention;

FIG. 2 is a simplified block diagram of a cellular phone which is part of the system shown in FIG. 1;

FIG. 3 is a simplified block diagram of a personal computer included in a call center which is part of the system shown in FIG. 1;

FIG. 4 is a simplified block diagram representation of software provided in the cellular phone of FIG. 2 in accordance with some aspects of the present invention; and

FIG. 5 is a diagram that illustrates interaction which occurs, in accordance with aspects of the invention, between the cellular phone and the call center.

### DETAILED DESCRIPTION

According to some embodiments, a data link is established between a cellular phone and a computer operated by a customer service representative at a call center. The cellular phone shares with the computer user interface display data generated by the cellular phone. The customer service representative views the user interface display data from the cellular phone and issues commands which are sent to the cellular phone to remotely control the cellular phone. The cellular phone may generate updated user interface data in response to the commands. The updated user interface data is transmitted to the call center and viewed on the computer by the customer service representative.

By directly controlling the cellular phone, the customer service representative may be able to solve a user's problem without engaging in a lengthy explanation to the user or attempting to talk the user through the problem. This may result in more efficient handling of questions/problems from cellular phone users.

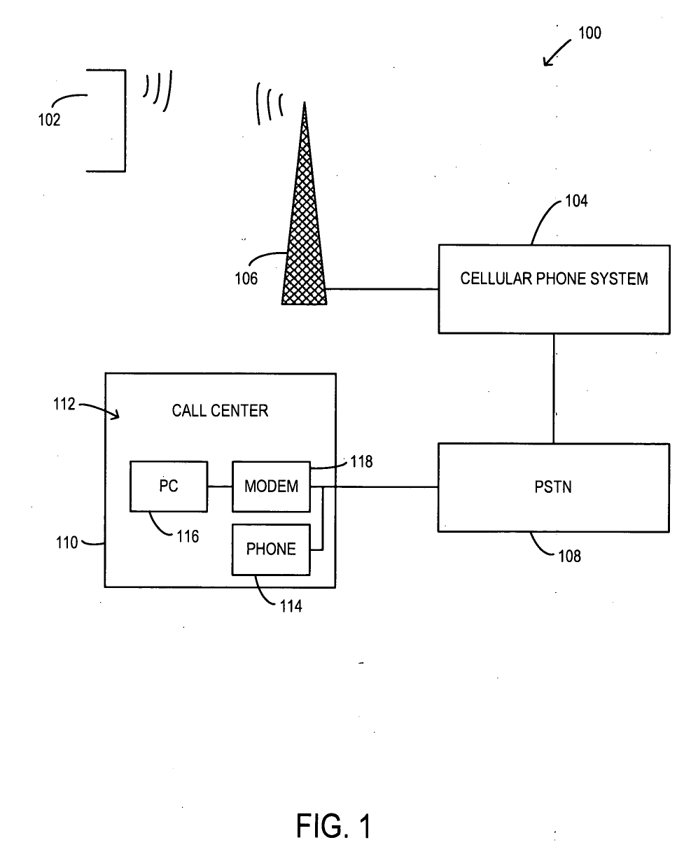

FIG. 1 is a simplified schematic block diagram of a communication system 100 provided in accordance with aspects of the present invention. The system 100 includes a cellular phone 102 and a cellular phone system 104. The cellular phone system, in turn, includes a cell antenna tower 106, with which the cellular phone 102 is in wireless communication. The system 104 also includes other system components, such as other antenna towers, transmitter/receivers, switching facilities, other cellular phones, and controllers. The controllers may be constituted by conventional server computer hardware.

The cellular phone system is connected to (and/or may be considered a part of) the public switched telephone network (PSTN), which is indicated by reference numeral 108. The PSTN 108, as is well known, includes other cellular telephone systems, as well as switching equipment and landline telephone facilities.

Also connected to the PSTN 108 is a call center 110. As one function of the call center 110 (or alternatively, as its sole function), the call center serves as a call-in help center for subscribers of the cellular phone system 104. To simplify the drawing, only one work station 112 of the call station 110 is shown. The work station 112 includes a telephone 114 for a customer service representative (not shown) and a computer 116 operated by the customer service representative. A modem 118 connects the computer 116 to the PSTN 108. Again to simplify the drawing other call center components are not shown, such as a call director and or a PBX which may provide the connections between the phone 114 and the modem 118 and the PSTN 108. In practice, the call center 110 may include a considerable number of work stations like workstation 112. It will be appreciated that the call center 110 need not be in the same country, or even on the same continent, as the cellular phone system 104.

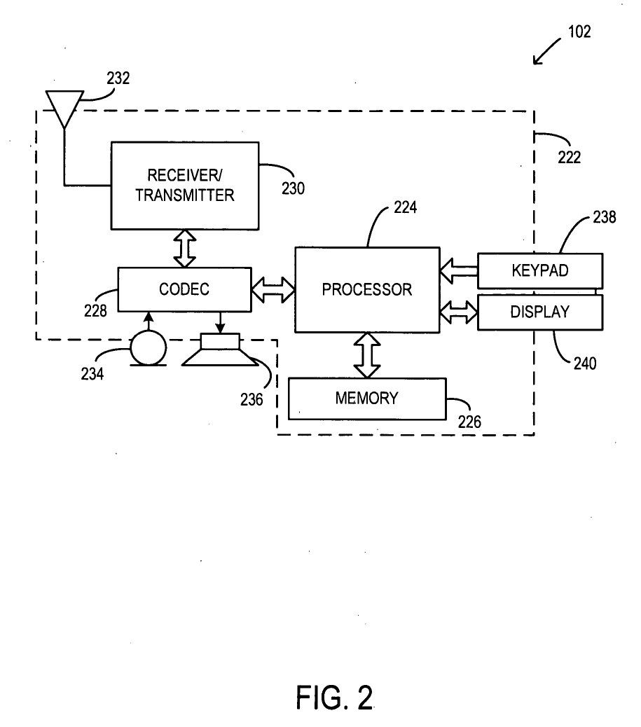

FIG. 2 is a partial schematic block diagram of the cellular phone 102. The cellular phone 102 may be completely or largely conventional in terms of its physical components, and may be programmed to perform certain functions in accordance with aspects of the present invention.

The cellular phone 102 includes a housing 222, which is represented by a dashed line. The housing 222 may be shaped and sized to fit in a user's hand. Other components of the cellular phone 102, which are described below, are mounted on or within the housing 222.

The cellular phone 102 also includes a processor 224, which may be a conventional microprocessor, microcontroller and/or digital signal processor (DSP) or other control circuit conventionally provided in a cellular phone. Also included in the cellular phone 102 are memory components 226, which may include one or more of ROM (read only memory), RAM (random access memory, e.g., static RAM), and flash memory. The processor 224 is in data communication with the memory components 226. The memory components 226 may store software programs that control operation of the processor 224. Some of the software may be conventional. Other portions of the software may be provided in accordance with the present invention to cause the processor 224 to perform functions that are described below.

A conventional codec (coder/decoder) 228 is also included in the cellular phone 102 and is in data communication with the processor 224. A conventional receiver/transmitter 230 is operatively coupled to the codec 228 and is also operatively coupled to a conventional antenna 232. A conventional microphone 234 is operatively coupled to the codec 228 to provide voice input signals to the codec 228. A conventional speaker 236 is also operatively coupled to the codec 228 and is driven by the codec 228 to provide audible output.

The user interface of the cellular phone 102 includes a keypad 238 and a display 240, which are both operatively coupled to the processor 224. The keypad 238 may be a conventional 12-key telephone keypad, by which the user may provide dialing and other input to the processor 224. The keypad may also include one or more soft-keys and/or one or more function keys. In some embodiments, the display 240 is a touch screen capable of both outputting data to the user under the control of the processor 224 and receiving manual input from the user for the processor 224. In other embodiments, the display 240 is not a touch screen and therefore only outputs data to the user. In such cases, user inputs are provided to the processor 224 via the keypad 238 and/or via other keys or buttons which are not separately shown.

It will be understood that the block diagram representation in FIG. 2 of the cellular phone 102 is simplified in a number of ways. For example, all power and power management components of the cellular phone 102 are omitted from the drawing.

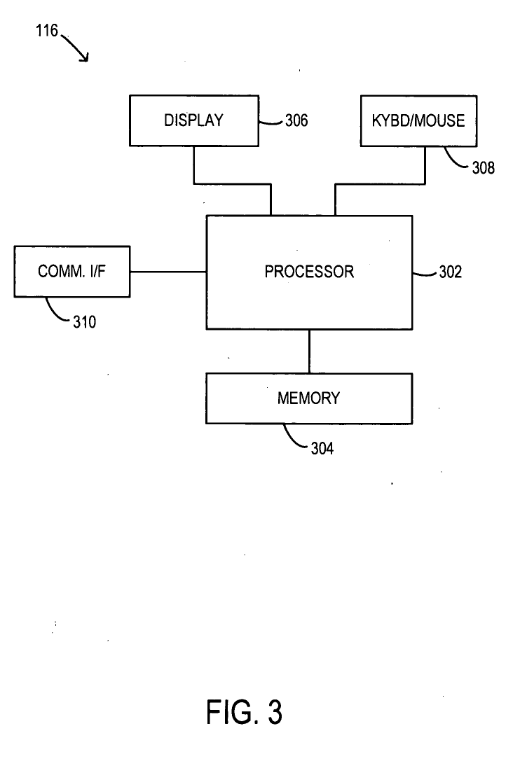

FIG. 3 is a simplified block diagram of the computer 116 of the call center 110. The computer 116 may, for example, be a personal computer. The personal computer may be conventional in terms of its hardware aspects.

The computer 116 includes a processor 302 which may be a conventional microprocessor. The computer also includes one or more memory and/or storage devices, represented by block 304. The memory/storage components are in data communication with the processor 302. The memory/storage components may include RAM (random access memory) to serve as working memory and for temporary program storage, ROM (read only memory) for storing firmware, boot code, etc., and one or more mass storage devices such as a hard disk, a CD-ROM drive, etc.

The computer 116 also includes a conventional display component 306, such as a flat panel display or a CRT. The display is directly or indirectly coupled to the processor 302 and is controlled either by the processor 302 or by another device (not shown) which is under the control of the processor 302. The display component 306 is positioned in such a manner as to be viewable by a customer service representative (not shown) who is operating the computer 116.

The computer 116 further includes conventional user input components (indicated by block 308) such as a keyboard and mouse. The user input components 308 are operated by the customer service representative to provide input to the computer 116. In accordance with conventional practices, the computer 116 may be programmed such that the display components 306 and the user input components 308 present one or more graphical user interfaces to the customer service representative.

In addition, the computer 116 includes a communication interface 310. The communication interface 310 is coupled to the processor 302 and provides an interface between the processor 302 and the modem 118 (FIG. 1, not shown in FIG. 3). The computer 116 may be programmed in accordance with the invention to perform functions described below. That is, one or more of the memory components 304 may store software instructions that allow the computer 116 to operate in a manner described below.

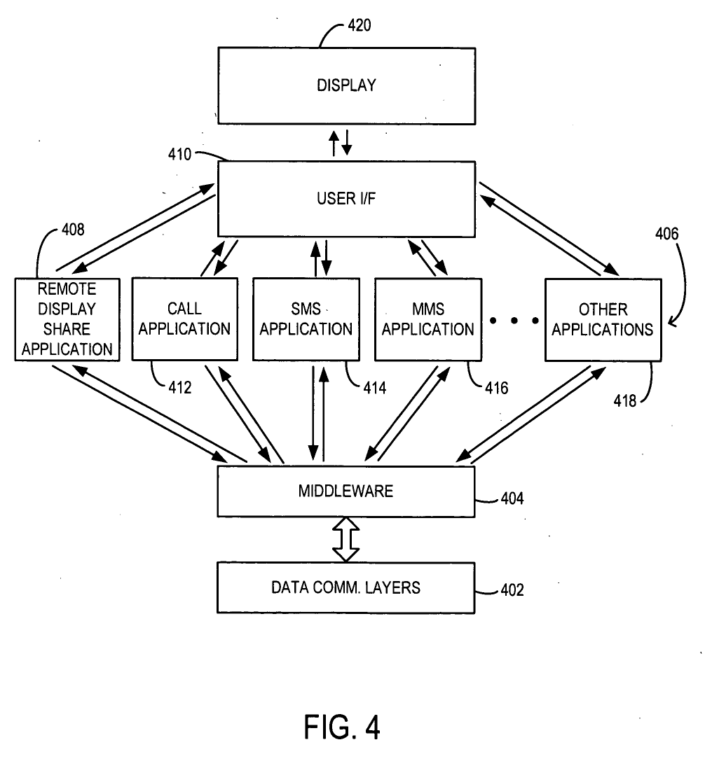

FIG. 4 is a block diagram representation of some components of software that is stored in the memory 226 (FIG. 2) of the cellular phone 102 and which controls the processor 224. The software modules shown in FIG. 4 include one or more data communication software layers, represented by block 402. The software in the cellular phone also includes middleware 404 which provides one or more software interfaces between the data communication software layers 402 and application programs 406, which will now be described. Data is exchanged between the data communication software layers 402 and the middleware 404.

The application programs 406 include a remote display sharing application 408 which will be further described below. As will be seen, the remote display sharing application 408 is also operative to receive commands transmitted to the cellular phone and to pass the commands on to other software components of the cellular telephone. The remote display sharing application 408 exchanges data with the middleware 404 and with a user interface program block 410.

The application programs 406 also include a call management application 412 which manages participation of the cellular phone in telephone calls directed to or initiated from the cellular phone. The call management application 412 exchanges data with the middleware 404 and with the user interface program block 410.

The application programs 406 also include an SMS application 414 which allows the cellular phone to engage in messaging via the well-known SMS (short message service) protocol. The SMS application 414 exchanges data with the middleware 404 and with the user interface program block 410.

The application programs 406 also include an MMS application 416 which allows the cellular phone to engage in messaging via the well-known MMS (multimedia messaging service) protocol. The MMS application 414 exchanges data with the middleware 404 and with the user interface program block 410.

The application programs 406 may also include other application programs, represented by block 418. For example, such other application programs may include a program to allow the cellular phone to take pictures via a camera component which is not shown, and to transmit the pictures to another cellular phone. The other application programs may also include, e.g., a database manager that manages and stores information which provides a history of calls made to and from the cellular phone. The database manager may also manage telephone number lists and the like. The other application programs 418 may exchange data with the middleware 404 and with the user interface program block 410.

The user interface program block 410 may receive and interpret input from the user of the cellular phone and may generate data to drive the display component of the cellular phone.

The software which controls the cellular phone also includes a display driver 420. The display driver controls the display component 240 (FIG. 2) of the cellular phone and exchanges data with the user interface program block 410.

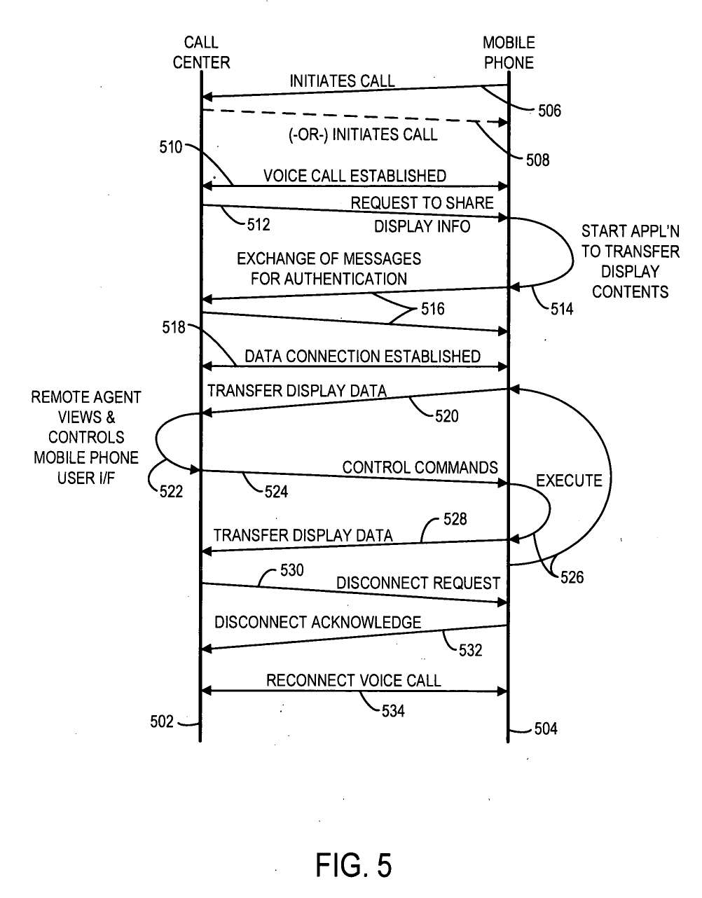

FIG. 5 is a diagram that illustrates a series of events that occur in a session in which the cellular phone 102 is remotely controlled by the computer 116 of the call center 110. FIG. 5 illustrates processes carried out in both the cellular phone 102 and the computer 116. These processes are the result of respective software which programs the cellular phone 102 and the computer 116 in accordance with aspects of the invention. This software may include the remote display sharing program 408 referred to above. This software may be stored in the memory 226 (FIG. 2) in the case of the cellular phone 102, or in the memory components 304 (FIG. 3) in the case of the computer 116.

In FIG. 5, the left-hand vertical line 502 represents the call center 110. More specifically, arrows which emerge from vertical line 502 represent actions taken by the call center 110/computer 116.

The right-hand vertical line 504 represents the cellular phone 102. More specifically, arrows which emerge from vertical line 504 represent actions taken by the cellular phone 102.

As indicated at 506, the cellular phone may initiate a telephone call to the call center to begin a subscriber help session for the user of the cellular phone. This may occur by the user of the cellular phone dialing the telephone number (e.g., a toll-free number) of the call center (or of a help desk function for the cellular phone system maintained in the call center).

Alternatively, the subscriber help session may be begun by the call center calling the cellular phone, as indicated at 508.

Whether initiated from the cellular phone or from the call center, the other party picks up to establish the call, as indicated at 510. The user of the cellular phone may then engage in a voice dialog with the customer service representative to describe the user's problem to the customer service representative. Once the customer service representative has learned what the problem is, the customer service representative may operate the computer to send to the cellular phone a request 512 for the cellular phone to share the cellular phone user interface display data with the computer. (At this point or before, the cellular phone may launch the remote display sharing program 408. For example, the user may enter a sequence of key strokes or select a menu item to launch the remote display sharing program 408. The customer service representative may instruct the user how to operate the cellular phone to launch the remote display sharing program. Alternatively, the remote display sharing program 408 may constantly idle in background while the cellular telephone is powered up, and may “wake up” when invoked by the request from the call center computer or when triggered by suitable input via the keypad of the cellular phone.) The curved arrow 514 represents launching of the remote display sharing program.

The information transmissions indicated at 516 are performed for the cellular phone and the call center to authenticate each other. Once authentication is complete, a data connection is established (indicated at 518) between the cellular phone and the computer 116 (FIG. 1) via the PSTN 108 and the cellular phone system 104. The data connection may be via a known data transfer protocol such as GPRS, EDGE or UMTS or via a voice connection. Then, via operation of the remote display sharing application 408 (FIG. 4) in the cellular phone, the cellular phone transmits (indicated at 520 in FIG. 5) to the computer 116, display data that the cellular phone has generated for display on the display component 240 (FIG. 2). The computer 116 receives the display data from the cellular phone and displays the display data (on display component 306, FIG. 3)) so that the customer service representative at the call center is able to remotely view the user interface display information provided by the cellular phone (522, FIG. 5). With the problem stated by the cellular phone user in mind, the customer service representative provides input to the computer 116 so that the computer generates a control command for the cellular phone. The control command is then transmitted (524, FIG. 5) from the computer to the cellular phone via the PSTN and the cellular phone system. The cellular telephone then receives the control command and responds accordingly, by, for example, changing a configuration of the cellular phone, as indicated at 526. Further, in response to the command the cellular phone may generate updated display information which is transmitted back to the computer (528, FIG. 5) to keep the customer service representative informed about the effect on the cellular phone of the commands transmitted to the cellular phone from the computer 116. The cycle of command transmitted to the cellular phone from the computer and updated display information transmitted to the computer from the cellular phone may be repeated a number of times as the customer service representative navigates through menus on the cellular phone and takes other actions to diagnose and solve the problem reported by the cellular phone user.

To give one example, suppose the problem reported by the cellular phone user is that the cellular phone does not ring to signal incoming calls. The customer service representative may operate the computer 116 to navigate through menus of the cellular phone to reach a menu which allows the ring tone to be re-enabled. The customer service representative may exercise the suitable menu selection so that the ring tone is restored.

As another example, the cellular phone user may report that he/she is unable to access data messages. The customer service representative may navigate through menus to check the SMS settings of the cellular phone and may change the settings as required.

Once the display information transmitted from the cellular phone to the computer and viewed by the customer service representative indicates that the problem has been solved, the customer service representative may operate the computer so that the computer sends a request 530 to the cellular phone to disconnect the data exchange session. The cellular phone may send a response 532 to the request, which results in a reconnection 534 of the voice call session. The customer service representative may then advise the user of the cellular phone that the problem has been solved, and the help session may then be concluded.

With this arrangement, a customer service representative may exercise remote control over a cellular phone to expeditiously resolve a problem reported by the user of the cellular phone. In some embodiments, the computer may be pre-programmed with sets of commands that are suitable for solving common problems reported by cellular phone users. The customer service representative may in these cases simply select the appropriate sequence of commands, which are then automatically sent to the cellular phone from the computer.

Remote control of a cellular phone has been described above in the context of a customer help desk. Alternatively, a cellular phone may be remotely controlled for other purposes, such as downloading content (e.g., video, games, ring tones) from the cellular phone or using the cellular phone for surveillance (e.g., via a camera included in the cellular phone), or for a video conference. In some embodiments a cellular phone may be remotely controlled by another cellular phone rather than by a remote computer.

Although the system has been described in detail in the foregoing embodiments, it is to be understood that the descriptions have been provided for purposes of illustration only and that other variations both in form and detail can be made thereupon by those skilled in the art without departing from the spirit and scope of the invention, which is defined solely by the appended claims.

What is claimed is:

1. A method of operating a cellular telephone, the method comprising:
generating display data which represents a user interface display suitable for presentation on a display component of the cellular telephone; and
transmitting said display data to a cellular telephone network that is in communication with said cellular telephone.

2. The method of claim 1, further comprising:
displaying said user interface display on said display component of the cellular telephone.

3. The method of claim 1, further comprising:
receiving a command that was generated by a computer and transmitted to said cellular telephone via said cellular telephone network;
responding to said command by generating updated display data which represents an updated user interface display; and
transmitting said updated display data to said cellular telephone network.

4. A method of operating a cellular telephone, the method comprising:
receiving and displaying, at a computer, user interface display data generated by the cellular telephone and transmitted to the computer via a cellular telephone network; and
controlling the cellular telephone by commands generated by the computer and transmitted to the cellular telephone via the cellular telephone network.

5. The method of claim 4, wherein said commands are generated by said computer in response to input from a user of said computer entered via a user interface of said computer.

6. The method of claim 5, wherein said computer is a personal computer.

7. The method of claim 6, wherein the personal computer is installed at a call center.

8. The method of claim 7, further comprising:
receiving a telephone call from the cellular telephone at said call center, said telephone call received prior to said steps of receiving and displaying user interface display data and controlling the cellular telephone by commands generated by the computer.

9. A cellular telephone, comprising:
a housing;
a microphone mounted in or on the housing;
a speaker mounted in or on the housing;
a processor mounted in the housing;
communication means, operatively coupled to the processor for receiving and transmitting information;
a display component operatively coupled to the processor; and
a memory operatively coupled to the processor and storing software adapted to control the processor to:
generate display data which represents a user interface display suitable for presentation on the display component; and
transmit said display data to a cellular telephone network that is in communication with the cellular telephone.

10. The cellular telephone of claim 9, wherein the software stored in the memory is further adapted to control the processor to cause the display component to display said user interface display.

11. The cellular telephone of claim 9, wherein the software stored in the memory is further adapted to control the processor to cause the display component to:
receive a command that was generated by the computer and transmitted to said cellular telephone via said cellular telephone network;
respond to said command by generating updated display data which represents an updated user interface display; and
transmit said updated display data to said cellular telephone network.

12. A computer comprising:
a processor;
a display component operatively coupled to the processor;
a memory operatively coupled to the processor and storing software adapted to control the processor to:
receive, and cause the display component to display, user interface display data generated by a cellular telephone and transmitted to the computer via a cellular telephone network; and
control the cellular telephone by commands generated by the processor and transmitted to the cellular telephone via the cellular telephone network.

13. The computer of claim 12, wherein said commands are generated by the processor in response to input from a user of the computer entered via a user interface of the computer.

14. The computer of claim 13, wherein the computer is a personal computer.

15. An article of manufacture comprising:
a computer readable medium having computer readable program code means embodied therein for causing a computer coupled to said medium to remotely control a cellular telephone, the computer readable program code means in said article of manufacture comprising:
computer readable program code means for receiving and displaying, at the computer, user interface display data generated by the cellular telephone and transmitted to the computer via a cellular telephone network; and
computer readable program code means for controlling the cellular telephone by commands generated by the computer and transmitted to the cellular telephone via the cellular telephone network.
